(19) United States
(12) Patent Application Publication
(10) Pub. No.: US 2009/0144695 A1
(43) Pub. Date: Jun. 4, 2009

(54) Method for ensuring consistency during software development

(76) Inventors: Vallieswaran Vairavan, Chennai (IN); Umesh Bellur, (US)

Correspondence Address: LOUIS VENTRE, JR, 2483 OAKTON HILLS DRIVE, OAKTON, VA, 22124-1530, US

(21) Appl. No.: 12/324,956

(22) Filed: Nov. 28, 2008

(30) Foreign Application Priority Data
Nov. 30, 2007 (IN) 2822/CHE/2007

(51) Int. Cl. G06F 9/44

(52) U.S. Cl. 717/105

(57) ABSTRACT

A method and system for checking consistency of a software system during software system development is disclosed. The software system comprises a source code and a plurality of design diagrams. The source code is represented as a source perspective diagram. A relational meta-model of the software system is prepared based on relationships between the plurality of design diagrams and the source perspective diagram. Thereafter, a plurality of consistency rules are applied on the relational meta-model to verify consistency of the software system. Consistency gaps identified in the software system are reported to a programmer of the software system.

### TECHNICAL FIELD

The present invention relates to the field of software development and more specifically to the field of maintaining consistency of software system during software development.

### BACKGROUND ART

Definitions of terms as used herein follow.

Configuration management tool (CMT): CMT is a tool used for tracking and controlling changes in a software system.

Sequence Diagram: A sequence diagram is an interaction diagram in UML, and shows how processes operate with each other and in what order.

UML: Unified modeling language (UML) is a standardized modeling language in the field of software system development. UML includes a set of graphical notation techniques to create abstract models of specific software systems.

XMI: The XML Metadata Interchange (XMI) is used for exchanging metadata information via extensible markup language (XML). XMI is most commonly used as an interchange format for UML models and it can also be used for serialization of models of other languages.

Object: In the programming languages considered herein, an object is created as an instance of a class. An object may contain data, instructions operating on the data or both.

Association: Association refers to a bidirectional connection between two entities. Wherein, entities include but are not limited to objects, components, and the likes.

Generalization: Generalization refers to a unidirectional inheritance relationship that associates two or more objects, wherein one object is a sub-type of another object (super-type). The object belonging to the sub-type may be substituted for the object belonging to the super-type.

State machine: The term state machine refers to the behavior of collaboration, specified as a collection of actions carried out over a sequence of state changes. State machine is also referred to as finite state automata or finite state machine.

As is well known, software development is an iterative process. An existing software system undergoes a plurality of iterations for subsequent improvements. Programmers create abstract models of software using a software modeling language, wherein these abstract models are referred to as designs of the software. A source code is then developed to implement the designs of the software. The source code and the designs of the software together comprise the software system. The designs are visual and at a higher level of abstraction than the source code. Hence, any change made to the designs is easier to comprehend than a corresponding change to the source code. This makes the designs an important tool for evolving and improving the software system.

Unified Modeling Language (UML) is a standardized software modeling language. UML uses graphical notation to create the designs of the software. The designs of the software comprise a plurality of design diagrams, each diagram being a partial graphical representation of a particular design. The plurality of design diagrams include: structure diagrams, behavior diagrams and interaction diagrams.

In order to ensure a working software system, all the design diagrams created for the designs of the software are correlated and consistency checks between the design diagrams are conducted. If two design diagrams in the software system contain contradictory common information, then there is an inconsistency between the diagrams. For example, suppose there exists a design diagram for message sequence chart in a software system. If a method of an object of the message sequence chart is called and a corresponding class in a class diagram of the software system does not contain the called method, then there exists an inconsistency in the software system.

The complex nature of the software systems makes it necessary for programmers to ensure consistency between a plurality of components of the software system in order to avoid valuable time and resources in identifying errors and inconsistencies in the software system. Further, it is a common practice in software development that different programmers develop codes for different design diagrams. Therefore, each design diagram and the code developed for that diagram could be independently developed and edited. In such a case, maintaining consistency in the entire software system becomes even more difficult as changes in a particular design diagram may not be reflected in the entire software system. Therefore, plurality of consistency rules is manually followed by the programmers in order to avoid inconsistencies in the software system. But as the complexity of the software system increases, following the consistency rules manually proves to be difficult and lead to inconsistencies in the software system. Therefore a method is required to automate the consistency checking of the software system; and prompt the programmers in case of any inconsistencies.

US Patent Publication application 20070079267 titled “Multi-format Consistency Checking Tool” discloses a system and method for performing consistency checking of one or more design diagrams of designs of a software system having different design types.

Journal of Object Technology (JOT) publication, Vol. 1, No. 2, July-August 2002, titled “Debugging UML Designs with Model Checking”, discloses a method of verifying one diagram against a second design diagram for consistency checking between the two design diagrams of design of software system.

Conventional methods allow for consistency checking of different design diagrams created for software by applying a plurality of predefined rules comprising of rules for consistency checking of different design diagrams and runtime consistency checking.

Hence, for ensuring a working software system, consistency checks are performed on different design diagrams. However, even after verifying the consistency between the design diagrams, errors may occur in the software system due to inconsistencies between the design diagrams and the source code. The errors in the software system due to inconsistencies between the design diagrams and the source code could be identified and corrected by the programmers either manually or by using debugging tools, which consume valuable time and resources of the programmers.

In light of the above mentioned methods, there exists a need for a method of consistency checking of entire software system including the consistency checking between the design diagrams and the source code to improve the process of software system development. Further, there is a need to fully automate the process of identifying errors in the software system. Automation of consistency checking reduces time and efforts required to develop the software system.

### SUMMARY OF THE INVENTION

A method for checking consistency of a software system during software system development is disclosed. The software system comprises a source code and a plurality of design diagrams, each design diagram comprising at least one design entity. The source code is represented as a source perspective diagram, wherein the source perspective diagram comprises at least one code entity. A relational meta-model of the software system is prepared based on relationships between the plurality of design diagrams and the source perspective diagram. The plurality of design entities is inter-related and relationships between the plurality of design entities and at least one code entity are established in the relational meta-model. Thereafter, a plurality of consistency rules are applied on the relational meta-model in order to verify the consistency of the software system. Consistency of the software system comprises consistency between the plurality of design diagrams, consistency between the plurality of design diagrams and the source code and run-time consistency of the plurality of design entities and at least one code entity present in the relational meta-model. Thereafter, consistency gap is identified in the software system and is reported to a programmer of the software system in the form of hierarchical reports. The hierarchical reports comprise the exact path in the software system to reach the consistency gap.

A system for checking consistency of a software system during software system development is disclosed. A source perspective diagram generator converts the source code to a source perspective diagram, wherein the source perspective diagram comprises at least one code entity. A model generator creates the relational meta-model of the software system by linking the plurality of entities based on relationships between the plurality of design diagrams and the source perspective diagram. Thereafter, consistency module comprising runtime consistency checking module, single entity consistency checking module and cross entity consistency checking module apply a plurality of consistency rules on the relational meta-model in order to verify the consistency of the software system. The consistency gap identified in the software system by the consistency module is transferred to a report generator. The report generator creates hierarchical reports comprising exact path in the software system to reach the consistency gap. The hierarchical reports are transferred to the programmer of the software through a user interface.

### BRIEF DESCRIPTION OF DRAWINGS

FIG. 1 is a schematic representing relational meta-model created for verifying consistency of a software system during software system development in accordance with an embodiment of the invention.

FIG. 2 is a detailed schematic representing relationship between deployment perspective diagram, requirements perspective diagram and development perspective diagram in accordance with an embodiment of the invention.

FIG. 3 is a detailed schematic representing relationship between development perspective diagram and source perspective diagram in accordance with an embodiment of the invention.

FIG. 4 is a detailed schematic representing relationship between deployment perspective diagram, requirements perspective diagram, development perspective diagram and source perspective diagram of a software system developed in an aspect oriented programming environment in accordance with an embodiment of the invention.

FIG. 5 is a schematic representing software system development environment 500, in accordance with an embodiment of the invention.

FIG. 6 is a schematic representing in details consistency checking system 506, in accordance with an embodiment of the invention.

FIG. 7 is a schematic representing an entity in a relational meta-model created for verifying consistency of the software system during software system development in accordance with an embodiment of the invention.

FIG. 8 is a flow diagram illustrating a method for checking consistency of the software system during software system development in accordance with an embodiment of the invention.

FIG. 9 is a flow diagram illustrating preparing of the relational meta-model for the software system in accordance with an embodiment of the invention. And,

FIG. 10 is a flow diagram illustrating in detail the method for checking consistency of the software system during software system development in accordance with an embodiment of the invention.

### DESCRIPTION OF EMBODIMENTS

In the following description, for the purposes of explanation, specific details are set forth in order to provide a thorough understanding of the invention. However, it will be apparent that the invention may be practiced without these specific details. Various aspects and features of example embodiments of the invention are described in more detail hereinafter.

An embodiment of the present invention or any of its components may be embodied in the form of a processing machine. Typical examples of a processing machine include a computer, a programmed microprocessor, an integrated circuit, and other devices or arrangements of devices that are capable of implementing the steps of the method of the current invention. The processing machine executes a set of instructions that are stored in one or more storage elements, in order to process input data. The storage elements may also hold data or other information as desired. The storage element may be in the form of an information destination or a physical memory element present in the processing machine. The set of instructions may include various commands that instruct the processing machine to perform specific tasks such as the steps that constitute the method of the present invention. The set of instructions may be in the form of a software program. The software may be in various forms such as system software or application software. Further, the software might be in the form of a collection of separate programs, a program module with a larger program or a portion of a program module. The software might also include modular programming in the form of object-oriented programming. The processing of input data by the processing machine may be in response to user commands, or in response to results of previous processing or in response to a request made by another processing machine. A person skilled in the art can appreciate that the various processing machines and/or storage elements may not be physically located in the same geographical location. The processing machines and/or storage elements may be located in geographically distinct locations and connected to each other to enable communication. Various communication technologies may be used to enable communication between the processing machines and/or storage elements. Such technologies include session of the processing machines and/or storage elements, in the form of a network. The network can be an intranet, an extranet, the internet or any client server models that enable communication. Such communication technologies may use various protocols such as TCP/IP, UDP, ATM or OSI.

A method for checking consistency of a software system during software system development, the software system comprises a source code and a plurality of design diagrams, each design diagram comprising at least one design entity.

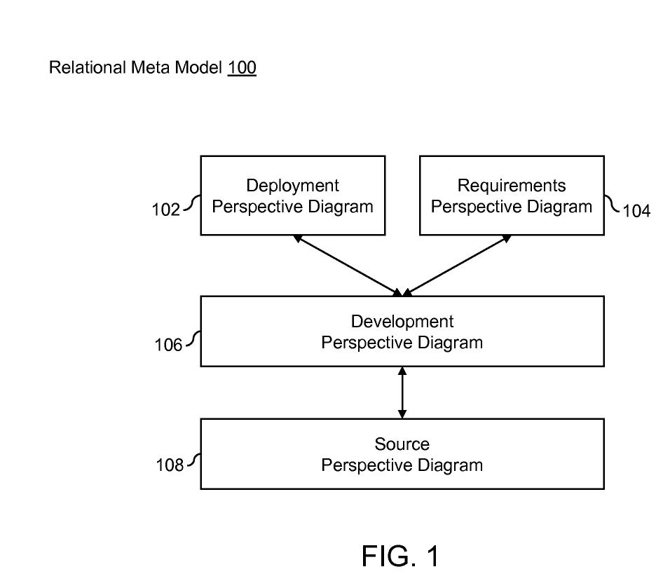

FIG. 1 is a schematic representing relational meta-model 100 created for verifying consistency of a software system during software system development, in accordance with an embodiment of the invention. Relational meta-model 100 comprises a plurality of design diagrams and displays relationships between the design diagrams. Relational meta-model 100 comprises a representation of the source code of the software and relationships between the source code and the design diagrams. The representation of the design diagrams and the source code and the relationships between them would facilitate in checking consistency of the software system and determination of consistency gap in the software system. Further, relational meta-model 100 includes deployment perspective diagram 102, requirements perspective diagram 104, development perspective diagram 106 and source perspective diagram 108. Deployment perspective diagram 102, requirements perspective diagram 104 and development perspective diagram 106 comprise a plurality of design entities. Source perspective diagram 108 comprises at least one code entity.

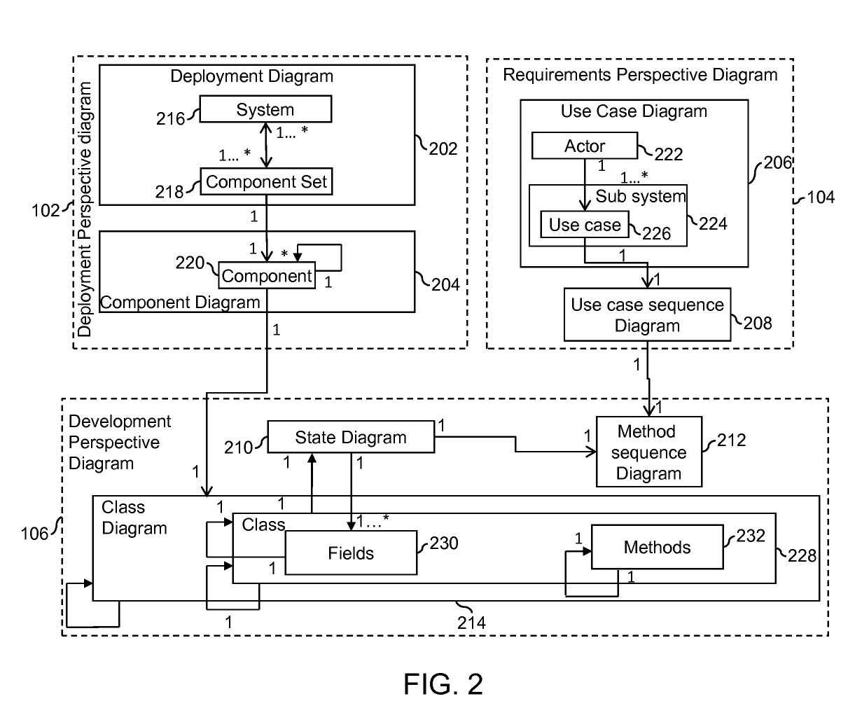

Deployment perspective diagram 102 represents deployment details of the software system and is used to generate builds of the software system from the source code. Builds of the software system refers to at least one software artifact that could be run on a computer obtained as a result of converting the source code into executable code after compilation. Deployment perspective diagram 102 is used by configuration management tools. Requirements perspective diagram 104 represents a plurality of requirements of the system. The requirements of a system comprise, but are not limited to actors, use cases and use case sequences. Actors, use cases and use case sequences are explained in further detail in conjunction with FIG. 2. Development perspective diagram 106 represents design of the software. The designs of the software are abstract models of the software, created by programmers, using a software modeling language. Development perspective diagram 106 is directly related to deployment perspective diagram 102, requirements perspective diagram 104 and source perspective diagram 108. Source perspective diagram 108 represents the source code of the software system. Source perspective diagram 108 has a bi-directional relationship with development perspective diagram 106.

FIG. 2 is a detailed schematic representing relationship between deployment perspective diagram 102, requirements perspective diagram 104 and development perspective diagram 106, in accordance with an embodiment of the invention. Deployment perspective diagram 102 includes deployment diagram 202 and component diagram 204. Deployment diagram comprises system 216 and component set 218. Component diagram 204 comprises component 220. Requirements perspective diagram 104 includes use case diagram 206 and use case sequence diagram 208. Use case diagram 206 comprises actor 222 and subsystem 224. Sub system 224 further comprises use case 226. Development perspective diagram 106 includes state diagram 210, method sequence diagram 212 and class diagram 214. Class diagram 214 includes class 228. Class 228 further comprises fields 230 and methods 232.

A plurality of links between the design entities represents the relationship between deployment perspective diagram 202, requirements perspective diagram 204 and development perspective diagram 206. “1” and “1 . . . *” denote the multiplicity of entities at the ends of a link. “1” denotes a single entity and “1 . . . *” denotes a plurality of entities. For example, suppose a link between two entities starts with “1” and ends with “1 . . . *”, it denotes a one-to-many relationship. A one-to-many relationship denotes a link between one entity and a plurality of other entities. Suppose a link between two entities starts with “1” and ends with “1”, it denotes a one-to-one relationship. A one-to-one relationship denotes a link between two single entities.

Deployment diagram 202 is linked to component diagram 204 for set of components 220. Component diagram 204 comprises at least one component 220 and describes properties of component 220. Component 220 is a component of the software which is ready for deployment. Component 220 in component diagram 204 is linked to class diagram 214 in development perspective diagram 106. Class diagram 214 comprises at least one class 228. Class 228 comprises fields 230 and methods 232. Fields 230 comprise definitions of a plurality of instances of class 228. Method 232 comprises a sequence of statements to perform an action, a set of inputs to customize the action and an output value of the action. Class 228 describes the source for components 220. The builds of the software system generated from deployment diagram 102 is based on relations between class 228 and component 220. Deployment perspective diagram 102 is used by configuration management tools.

The plurality of components 220 in component diagram 204 is inter-related. Deployment diagram 202 displays configuration of executable codes of the software system, a plurality of processes and entities of the software system. The configuration of executable codes, processes and entities of the software system comprises data which has to be taken as an input from an external system to execute the executable codes, processes and entities of the software system. System 216 describes physical system required for development and execution of the software system.

Requirements Perspective diagram 104 comprises use case diagram 206 and use case sequence diagram 208. Use case diagram 206 typically contains one or more use case 226. Use case 226 describes the interaction between an actor 222 and the software system, represented as a sequence of steps. Actor 222 provides stimulus to the software system and is defined as being outside the software system. Examples of actor 222 include but are not limited to, end users, other software systems and hardware devices. Use case 226 is linked to use case sequence diagram 208. Use case sequence diagram 208 describes sequence diagram of at least one use case 226. The collaborations between a plurality of use cases 226 and the sequence in which they are implemented are described by use case sequence diagram 208. Use case sequence diagram 208 refers to method sequence diagram 212 of development perspective diagram 106. Method sequence diagram 212 details the execution of method 232 in terms of dependencies on class 228 for realization of method 232.

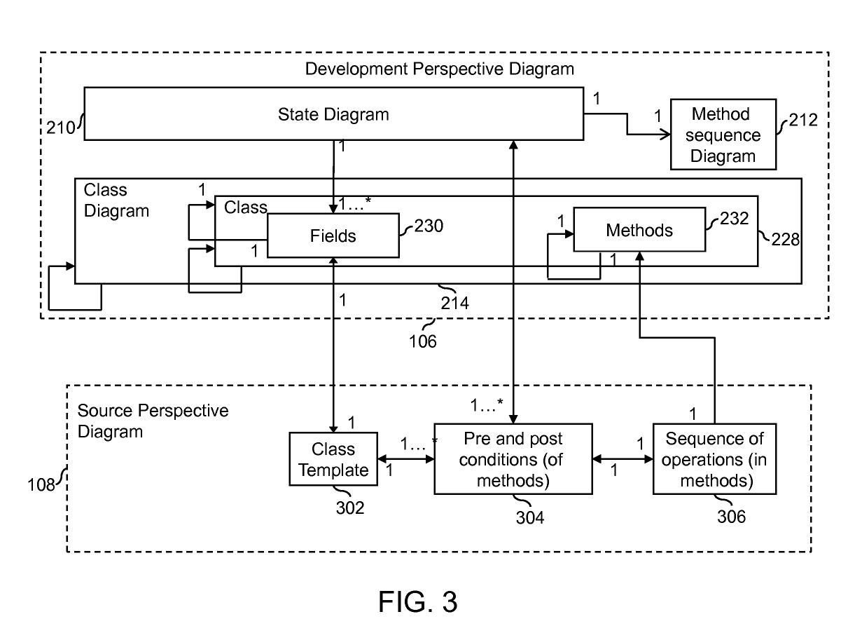

Development perspective diagram 106 represents the design of the software in the software system. Class diagram 214 comprises at least one class 228. Class 228 is associated with state diagram 210 and comprises at least one method 232. State diagram 210 utilizes method sequence diagram 212 for state transitions. State diagram 210 comprises but is not limited to states, transitions, activities, events and the like which are used to describe dynamics of the software system. State diagram 210 comprises a plurality of states of the plurality of design entities of the software system including but not limited to activation, deactivation, initialization and events of the plurality of design entities. State diagram 210 displays sequences of states which the plurality of design entities go through during runtime in response to received input, together with transitions and actions that the plurality of design entities undergo. Development perspective diagram 106 has bi-directional relation with source perspective diagram 108. The bidirectional relationship between development perspective diagram 106 and source perspective diagram 108 is described in conjunction to FIG. 3.

FIG. 3 is a detailed schematic representing relationship between development perspective diagram 106 and source perspective diagram 108, in accordance with an embodiment of the invention. Source perspective diagram 108 represents the source code of the software system and comprises at least one code entity. Source perspective diagram 108 includes class template 302, pre and post conditions 304 and sequence of operations 306. Class template 302, pre and post conditions 304 and sequence of operations 306 are code entities of source perspective diagram 108. Class diagram 214 in development perspective diagram 106 is converted to class template 302 in source perspective diagram 108. State diagram 210 in development perspective diagram 106 is converted to pre and post condition 304 in source perspective diagram 108. Method sequence diagram 212 in development perspective diagram 106 is converted to sequence of operations 306 in source perspective diagram 108. Hence, class diagram 214 is linked to class template 302, state diagram 210 is linked to pre and post condition 304 and method sequence diagram 212 is linked to sequence of operations 306.

Relation between source perspective diagram 108 and development perspective diagram 106 helps in maintaining consistency between the source code and the designs of the software in the software system. The consistency is maintained by utilizing state diagram 210, method sequence diagram 212 and class diagram 214 for source code generation. Pre and post conditions 304 ensure that state diagram 210 is consistent with properties of state diagram 210.

Source perspective diagram 108 is specific to programming language. For example, in Java state transition violations can be implemented by exceptions and report to user via exception handler. The relations between the source code and the designs are bi-directional since both are entities used in development of the software. The source code could be considered to be an entity in programming language specific format and the design could be considered to be an entity in a modeling language specific format. Development environments, compilers and interpreters use source perspective diagram 206.

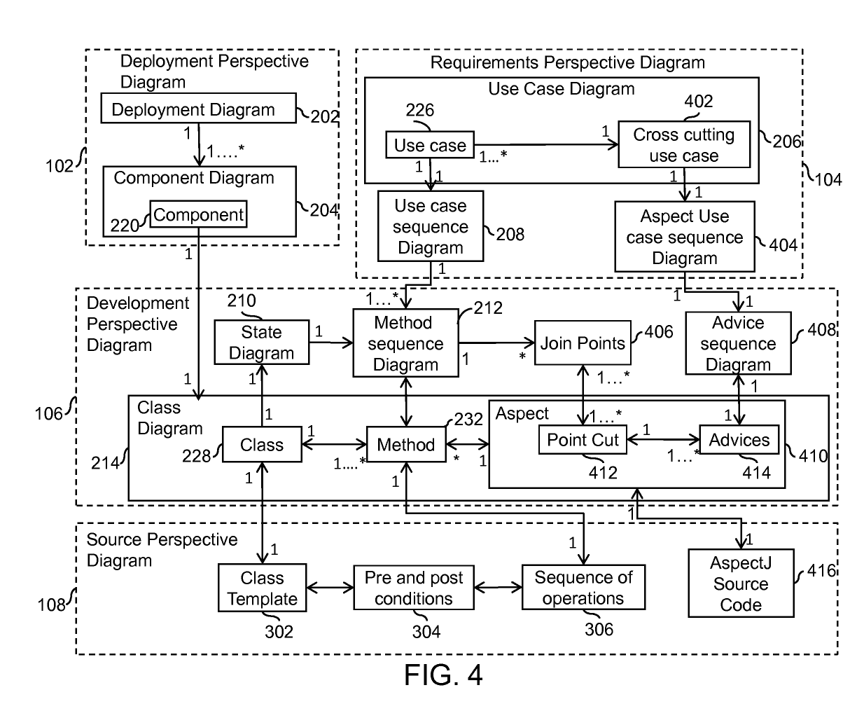

FIG. 4 is a detailed schematic representing relationship between deployment perspective diagram 102, requirements perspective diagram 104, development perspective diagram 106 and source perspective diagram 108 of the software system developed in an aspect oriented programming environment, in accordance with an embodiment of the invention.

Deployment perspective diagram 102 comprises deployment diagram 202 and component diagram 204 as described earlier in conjunction with FIG. 2.

Requirements perspective diagram 104 comprises use case diagram 206, use case sequence diagram 208 and aspect use case sequence diagram 404. Use case diagram 206 further comprises use case 226 and cross cutting use case 402. Use case 226 may have at least one cross cutting concern. The source code of any software system has a plurality of functionalities. Each of these functionalities is called a concern. However, there are some concerns that have to be used in more than one of the concerns. These concerns are called cross cutting concerns. Logging is an example of a cross cutting concern because logging necessarily affects every single logged part of the software system. Logging thereby crosscuts each logged class 228 and method 232. Cross cutting use case 402 represents the cross cutting concerns. Aspect use case sequence diagram 404 represents sequence of method 232 in cross cutting use case 402, wherein aspect use case sequence diagram 404 is linked to method 232 via advice sequence diagram 408 and class 228 respectively.

Development perspective diagram 106 comprises state diagram 210, method sequence diagram 212, class diagram 214, join points 406 and advice sequence diagram 408. Class diagram 214 further comprises class 228, method 232 and aspect 410. Aspect 410 further comprises point cut 41 2 and advices 414. Point cut 412 comprises a set of join points 406. Join points 406 comprise points in the source code where the cross cutting concerns are implemented in the source code. Advices 414 describe a class of functions which modify other functions when the latter are run. Advices 414 is applied at join points 406 of the source code. Advice sequence diagram 408 defines the sequence of execution of advices 414 in the source code at join points 406.

Source perspective diagram 108 comprises class template 302, pre and post conditions 304, sequence of operations 306 and aspect J source code 416. Aspect J source code 416 describes definitions of point cut 412 and advices 414 from aspect 410 in class diagram 214. Aspect J source code 416 further comprises advice code from advice sequence diagram 408.

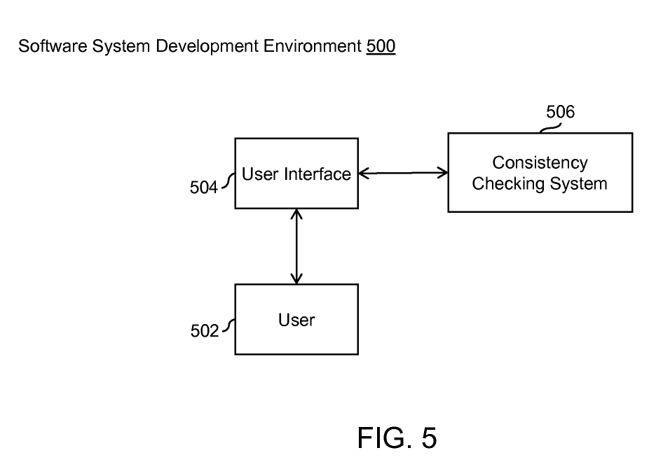

FIG. 5 is a schematic representing software system development environment 500, in accordance with an embodiment of the invention. Software system development environment 500 includes user 502, user interface 504 and consistency checking system 506. User 502 checks the consistency of the software system using consistency checking system 506 through user interface 504. In an embodiment of the invention, user 502 is the programmer of the software. In an embodiment of the invention, consistency checking system 506 is run on a computer system comprising Microsoft windows server 2003 as operating system, 1 Quad Core Intel Xeon L5420 processor, 2 GB installed RAM (fully buffered DIMMS) and 2×73 GB SAS SFF 2.5″ Drives (RAID). In another embodiment of the invention, consistency checking system 506 is run on a computer system comprising Red Hat Enterprise Linux as operating system, 1 Quad Core AMD Opteron 2347HE processor, 2 GB installed RAM (fully buffered DIMMS) and 2×73 GB SAS SFF 2.5″ Drives (RAID). It will be apparent to any person skilled in the art that the choice of the computer system is not a limitation of the invention.

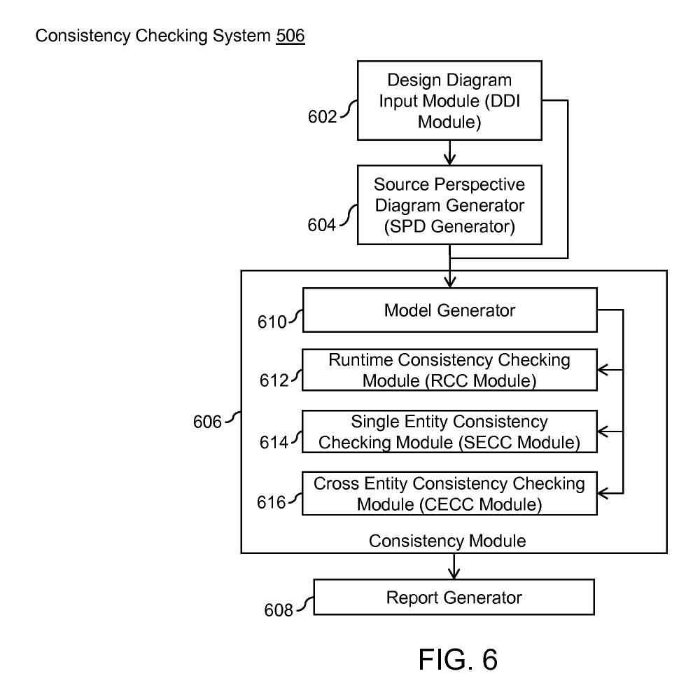

Consistency checking system 506 comprises a plurality of Java based applications. The plurality of applications is described in detail in conjunction with FIG. 6. Consistency gap identified by consistency checking system 506 is reported to user 502 as hierarchical reports through user interface 504. The hierarchical reports comprise path to be followed by user 502 in the software system to reach the consistency gap and type of consistency gap identified by consistency checking system 506.

FIG. 6 is a schematic representing in details consistency checking system 506, in accordance with an embodiment of the invention. Consistency checking system 506 includes design diagram input (DDI) module 602, source perspective diagram (SPD) generator 604, consistency module 606 and report generator 608. Consistency module 606 includes model generator 612, run-time consistency checking (RCC) module 614, single entity consistency checking (SECC) module 616 and cross entity consistency checking (CECC) module 618.

DDI module 602 receives the design diagrams of the software from user 502 through user interface 504. In an embodiment of the invention, the design diagrams received by DDI module 602 are in UML format and are converted to XMI format by DDI module 602. In another embodiment of the invention, the design diagrams received by DDI module 602 are in XMI format. SPD generator 604 receives the source code of the software, developed by user 502 from user interface 504. Thereafter, SPD generator 604 converts the source code of the software to source perspective diagram 108.

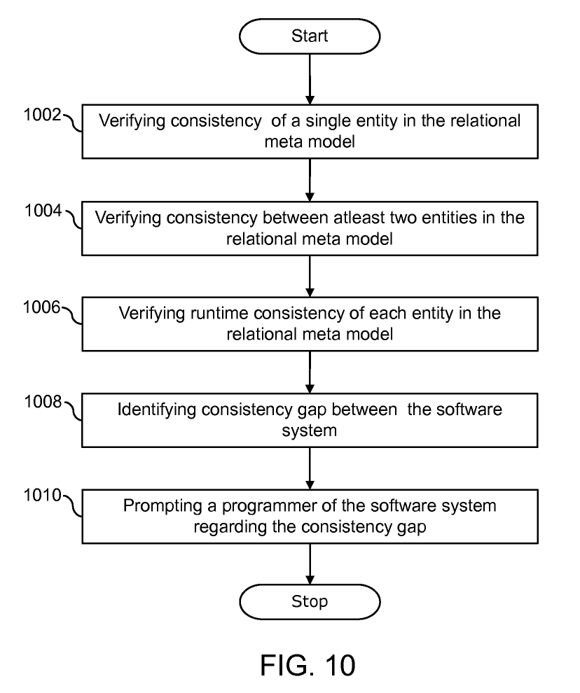

Model generator 610 receives the design diagrams in XMI format from DDI module 602 and source perspective diagram 108 from SPD generator 604. Thereafter model generator links entities based on the relationships between the entities as specified by user 502. Further, RCC module 612 receives relational meta-model 100 from model generator 610. A plurality of predefined run-time consistency rules is applied on relational meta-model 100 to identify consistency gap in the software system during run-time. The run-time consistency rules are described in detail in conjunction with FIG. 10.

SECC module 614 receives relational meta-model 100 from model generator 610. Thereafter, a plurality of well-formedness rules is applied on relational meta-model 100 for identifying the consistency gap in a single entity of relational meta-model 100. The well-formedness rules are described in detail in conjunction with FIG. 10. Further, relational meta-model is transferred to CECC module 616 by model generator 610. CECC module 616 applies a plurality of cross-entity consistency rules on relational meta-model 100 for identifying consistency gap between at least two entities. The cross-entity consistency rules are described in detail in conjunction with FIG. 10. The consistency gap identified by RCC module 612, SECC module 614 and CECC module 616 are transferred to report generator 608. Report generator 608, generates hierarchical report based on the consistency gap. The hierarchical reports are described in details in conjunction with FIG. 10.

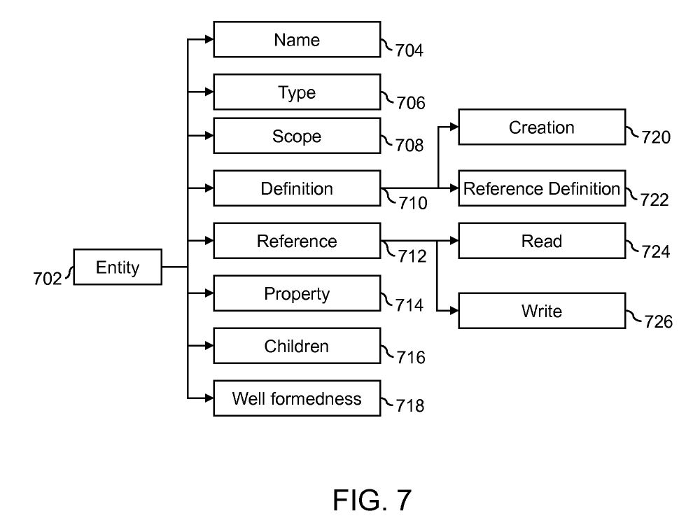

FIG. 7 is a schematic representing entity 702 in relational meta-model 100 created for verifying consistency of the software system during software system development, in accordance with an embodiment of the invention. Entity 702 includes design entities and code entities. Entity 702 has a plurality of parameters including but not limited to name 704, type 706, scope 708, definition 710, reference 712, property 714, children 716 and well formedness 718. Definition 710 has a plurality of parameters including but not limited to creation 720 and reference definition 722. Further, reference 712 has a plurality of parameters including but not limited to read 724 and write 726.

Name 704 denotes the name assigned to entity 702 during software system development. Type 706 denotes the type of entity 702. Design entity, code entity and the like are types of entity 702. Scope 708 describes level of accessibility of entity 702. For example, suppose the level of accessibility associated with entity 702, which is defined in class 228, is private, entity 702 could be used only within class 228. In case, the level of accessibility associated with entity 702 is public, entity 702 could be used by a plurality of classes 228. Definition 710 comprises creation 720 and reference definition 722. Creation 720 is a list of children entities, wherein the children entities are contained in entity 702. In another embodiment of the invention, the children entities in entity 702 are stored as XMI tree structure. Reference definition 722 comprises a set of XML tags created to define structure, property, relationships and the likes of entity 702.

Reference 712 is the set of referred entities which are referred to by a particular entity 702. Read 724 is a set of entities referred to by entity 702 through read reference wherein, the read reference copies the values of the set of entities to entity 702. Write 726 is a set of entities referred to by entity 702 through write reference, wherein write reference changes the values of the set of entities referred to by entity 702.

Property 714 comprises a list of properties of entity 702, such as user permissions, data of access modified and the like. Children 716 comprise list of children entities of entity 702 and a plurality of parameters associated with the children entities. The plurality of parameters associated with the children entities include but are not limited to name, type, properties and the like. Herein, the structure of the software system is maintained in XMI format. Well formedness 718 comprises well-formedness rules for creation 720 and entity 702, wherein, well-formedness rules are a set of rules used for maintaining consistency of a single entity 702. Well-formedness rules are described in detail in conjunction to FIG. 10.

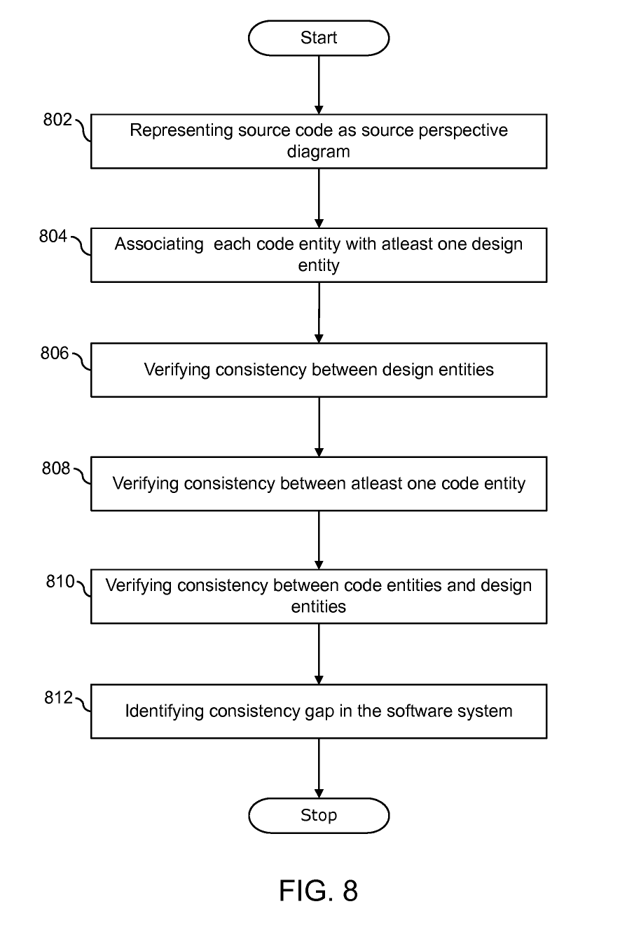

FIG. 8 is a flow diagram illustrating a method for checking consistency of the software system during software system development, in accordance with an embodiment of the invention.

The software system is developed by utilizing a plurality of design diagrams including but not limited to deployment diagram 202, use case diagram 206, state diagram 210, class diagram 214 and the like. In order to maintain consistency between the design diagrams and the source code, a plurality of consistency checks are conducted on the software system. In order to verify consistency between the source code and the design diagrams, the source code is represented as source perspective diagram 108 at step 802. Source perspective diagram 108 comprises at least one code entity. The at least one code entity is linked to a plurality of design entities of the design diagrams at step 804. Thereafter, consistency between design entities is verified by applying a first set of consistency rules at step 806. Wherein, the first set of consistency rules comprises single entity consistency rules, cross entity consistency rules and run-time consistency rules. The first set of consistency rules and verifying consistency between the design entities is described in details in conjunction to FIG. 10.

At step 808, consistency between the at least one code entity is verified based on a second set of consistency rules. Wherein, the second set of consistency rules comprises single entity consistency rules, cross entity consistency rules and run-time consistency rules. The second set of consistency rules and verifying consistency between the at least one code entity is described in details in conjunction to FIG. 10. In an embodiment, the first set of consistency rules is same as the second set of consistency rules.

At step 810, consistency between the at least one code entity and a plurality of design entities is verified based on a third set of consistency rules. Wherein, the third set of consistency rules comprise cross entity consistency rules. Verifying consistency between the at least one code entity and the plurality of design entities is described in details in conjunction to FIG. 10. Based on a plurality of consistency checks, consistency gap in the software system is identified at step 812.

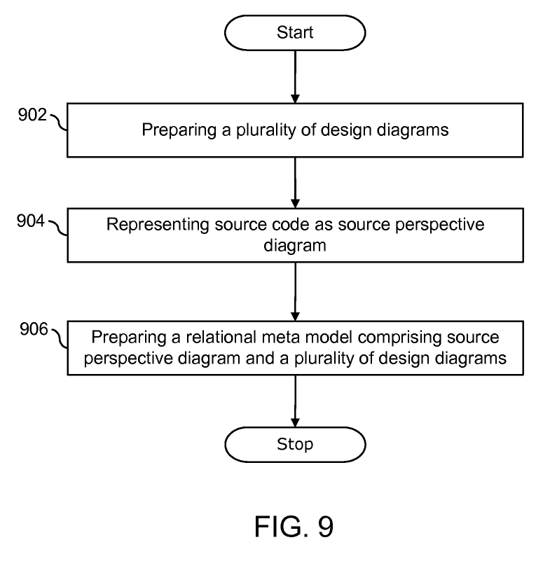

FIG. 9 is a flow diagram illustrating preparing of relational meta-model 100 of the software system, in accordance with an embodiment of the invention. In order to develop the software system, a plurality of design diagrams is prepared at step 902. The plurality of design diagrams is prepared in UML (unified modeling language) format and is converted to XMI format. In an embodiment, the plurality of design diagrams is prepared in XMI format. Further, the plurality of design diagrams in XMI format comprises a plurality of design entities, which are represented as XMI tree structure.

In an embodiment of the invention, the XMI tree structure of deployment diagram 202 is:

UML: System (Refers)+
UML: Component set (Refers)+

In an embodiment of the invention, the XMI tree structure for component diagram 204 is:

UML: Component set (Defines)
UML: components (Defines)+
   UML: component Association (Defines)
   UML: Class set (refers)

Wherein, “defines” outlines the structure of a particular entity and “refers” denotes at least one entity referred to by the particular entity. In an embodiment of the invention, default type of “defines” is creates which denotes creation 720. In another embodiment of the invention, default type of “refers” is read 724. Creation 720 and read 724 are described in detail in conjunction with FIG. 7.

Wherein, UML refers to the inter-convertibility of the structure of a particular entity in XMI to a corresponding structure of the entity in UML, “defines” outlines the structure of a particular entity and “refers” denotes at least one entity referred to by the particular entity. For example, in the XMI tree structure of component diagram 204, UML: Component Set (Defines) denotes that the structure of component diagram 204 could be converted to a corresponding structure in UML. Further, the structure of component diagram 204 comprises at least one component 220. Component 220 may be associated to another component, wherein the association refers to a set of classes.

In an embodiment of the invention, the XMI tree structure for use case diagram 206 is:

UML: Use_Case(Defines)
UML: SubSystem (Defines)+
   UML: Use-cases (Defines)+
   UML: actionsequence type: Use case (Refers)
   UML: Association (Defines)
   UML: Use cases (Refers)/UML: Actor (Refers)
   UML: generalization (Defines)
      UML: Use cases (Refers)

UML: Actor (Defines)+
UML: Association (Defines)+
   UML: Use cases(Refers)

In an embodiment of the invention, the XMI tree structure for use case sequence diagram 208 is:

UML: actionsequence type: Use case (Defines)
UML: actionsequence type: method (Refers)
UML: SubSystem Instance (Defines)
   UML: SubSystem (Refers)
UML: Class Instance (Defines)
   UML: class (Refers)

In an embodiment of the invention, the XMI tree structure for method sequence diagram 212 is:

UML: Action sequence type: method (Defines)

UML: Class (Refers)
UML: Method (Refers)
UML: Instance (Defines reference definition /Creates)+
   UML: Class (Refers)
      UML: State (Refers)
UML: Message (Defines)
   UML: Instance sender (Refers Read/Write)
   UML: Instance receiver (Refers Read/Write)
   UML: Methods (Refers)

Wherein, “defines” comprises reference definition 722 and creation 720; “refers” comprises read 724 and write 726. Reference definition 722 and write 726 are described in detail in conjunction with FIG. 7.

In an embodiment of the invention, the XMI tree structure of class diagram 214 is:

UML: Class Set (Defines)
UML: class (Defines)+
   UML: Association (Defines)+
      UML; class (Refers)
   UML: Attributes (Defines)
   UML: Methods (Defines)
      UML: actionsequence type: method (refers)
      UML: State_Machines (Refers)

Wherein, attributes are definitions of plurality of objects of class 228, actionsequence type denotes the sequence in which a plurality of method 232 is called in class 228.

In an embodiment of the invention, the XMI tree structure of state diagram 210 is:

UML: State_Machines (Defines)
UML: State (Defines)+
   UML: Attributes (Refers)+
   UML: Message (defines)*
      UML: State type: destination (Refers)
      UML: method (Refers)

At step 904, the source code of the software system is represented as source perspective diagram 108. Source perspective diagram 108 comprising at least one code entity, is prepared in UML format and is converted to XMI format for verifying consistency. In an embodiment, source perspective diagram 108 is prepared in XMI format. The at least one code entity in source perspective diagram 108 which is in XMI format is represented as XMI tree structure.

The source code comprises a plurality of code files which further comprise a plurality of classes, the plurality of code files are combined to prepare the source code. The plurality of code files are structured in a predefined format. In an embodiment, the predefined format for structuring of the plurality of code files, wherein the programming language used is Java, is:

Class_Name.java (defines)
<import specified >(form class diagram)
Class_Name {
<attributes list > (form class diagram)
<method list> (form class diagram)
<Method> {
<Pre-Condition > (from state diagram)
<method body>(from sequence diagram)
<post-condition>(from state diagram)
}
};

Thereafter, the plurality of design entities of deployment perspective diagram 102, requirements perspective diagram 104 and development perspective diagram 106 are linked to the at least one code entity of source perspective diagram 108 to prepare relational meta-model 100, at step 906. The relationship between the at least one code entity and the plurality of design entities is described in detail in conjunction to FIG. 2 and FIG. 3.

FIG. 10 is a flow diagram illustrating in detail the method for checking consistency of the software system during software system development, in accordance with an embodiment of the invention. At step 1002, consistency of a single entity 702 in relational meta-model 100 is verified. For verifying consistency of a particular entity 702, plurality of well-formedness rules are applied. In an embodiment of the invention, the well-formedness rules are same as the single entity consistency rules. The well-formedness rules for a particular type of entity 702 may be different from any other type of entity 702. In an embodiment of the invention, the well-formedness rules for use case diagram 206 are:
Each actor 222 must use at least one use case 226.
Each use case 226 must be used by at least one actor 222.
Each use case 226 must belong to system 216.
Each use case 226 must refer at least one use case sequence diagram 208.
In another embodiment of the invention, the well-formedness rules for use case sequence diagram 208 are:
Each instance of class 228 must be non-null and point to a valid class in class diagram 214.
Method sequence diagram 212 reference must not be null for each method 232 called and must point to a valid method sequence diagram 212.

In another embodiment of the invention, the well-formedness rules for method sequence diagram 212 are:
Each message must have a sender and a receiver entity 702.
Each entity 702 must be the sender or the receiver in at least one interaction.
Each entity 702 must refer a valid class diagram 214 and state diagram 210.
Each message must be an instance of method 232 for a particular defined class 228.
Each message must conform to the signature of method 232 corresponding to the message.

Wherein, the message refers to a function call in which an object is being called from another object. Sender and receiver are kinds of class 228. The message is created in the sender class. Receiver class receives the function call.

In another embodiment of the invention, the well-formedness rules for class diagram 214 are:
Each class diagram 214 must have at least one class 228.
Each association must have a source and target class 228.
Each class 228 must have at least one method 232.

In another embodiment of the invention, the well-formedness rules for state diagram 210 are:
State diagram 210 must have a start and end state.
State diagram 210 must be related to one and only one class 228.
State must be described by one or more fields 230 of class 228.
States should not have overlap of attribute values describing the state.
State changes must be done by messages corresponding to method sequence diagram 212.
Every state must be reachable from start
From every state the end state should be reachable
State diagram 210 must provide a non null reference to pre and post condition 304 of the source code corresponding to class 228.

Wherein, the start state refers to the initialization of an instance of class 228 and end state refers to the destruction of the instance of class 228.

In another embodiment of the invention, the well-formedness rules for component diagram 204 are:
Component diagram 204 must have at least one component 220.
Each relationship between two components 220 should have two terminating end classes. The terminating end classes are called boundary classes. The boundary classes must be a type of class 228 which must be valid in class diagram 214.

In another embodiment of the invention, the well-formedness rules for deployment diagram 202 are:
Deployment diagram 202 must be related to component diagram 204.
Component 220 in component diagram 204 should be mapped to system 216 described in deployment diagram 202.

In another embodiment of the invention, the well-formedness rules for the source code are:

The source code comprises a plurality of code files which further comprise a plurality of classes, the plurality of code files are combined to prepare the source code. The plurality of code files are structured in a predefined format. In an embodiment, the predefined format for structuring of the plurality of code files, wherein the programming language used is Java, is:

Class_Name.java (defines)
<import specified>(form class diagram)
Class_Name {
<attributes list> (form class diagram)
<method list> (form class diagram)
<Method>{
<Pre-Condition >(from state diagram)
<method body>(from sequence diagram)
<post-condition>(from state diagram)
}
};

Consistency between at least two entities 502 of relational meta-model 100 is verified at step 1004. In an embodiment, consistency between two design entities is verified. In another embodiment, consistency between two code entities is verified. In another embodiment consistency between a code entity and a design entity is verified.

In an embodiment, in order to verify consistency between two entities 502, plurality of cross-entity consistency rules is applied. For example, suppose there are ‘N’ design diagrams for the software system, each design diagram will have a defined set and referred set. So there will be ‘N’ defined sets D1, D2 . . . Dn and N referred sets R1, R2 . . . Rn. Further there will be a plurality of external definitions used in the software system. Wherein,
Dx={defined entities}={class, attribute, method}
Rx={referred entities}={class, method sequence diagrams and state machines}
ED={external definition from imports}={jdk 1.5 library}

The software system is considered to be consistent if and only if any referred item is defined somewhere in the software system. In other words the union of all the referred sets must be a proper subset of the union of all the defined sets. Mathematically: Union of (Rᵢ)⊂(Union of (Dᵢ))∪ED.

At step 1006, run-time consistency of each entity 702 is verified based on a plurality of predefined run-time consistency rules. In order to maintain run-time consistency of entity 702, a time sequence is made for entity 702, wherein the time sequence is made in form of finite state automata. The time sequence keeps track of a plurality of changes in entity 702 since creation of entity 702 till destruction of entity 702. Further, time sequences comprise a plurality of read references and write references for entity 702. The plurality of read references and write references are checked for consistency. Thereafter, consistency gap in the software system is identified based on the well-formedness rules, the cross-entity consistency rules and the run-time consistency rules, at step 1008. The consistency gap identified is converted to hierarchical reports. The hierarchical reports comprise path to be followed in the software system to reach the consistency gap and type of consistency gap identified. The hierarchical reports address the need to fully automate the process of identifying errors in the software system. Examples of the hierarchical reports include but are not limited to inconsistency report, timeline report, bugs analysis report, design review graph and the like. Thereafter the hierarchical reports are sent to programmer of the software system at step 1010. The hierarchical reports enable the programmer of the software system to modify the software system in order to fill the consistency gap identified.

While example embodiments of the invention have been illustrated and described, it will be clear that the invention is not limited to these embodiments only. Numerous modifications, changes, variations, substitutions and equivalents will be apparent to those skilled in the art without departing from the spirit and scope of the invention.

What is claimed is:

1. A system for checking consistency of a software system during software system development, the software system comprises a source code and a plurality of design diagrams, each design diagram comprising one or more design entities, the system comprising:
(a) a source perspective diagram generator, the source perspective diagram generator configured to represent the source code of the software system as a source perspective diagram, the source perspective diagram comprising one or more code entities;
(b) a model generator, the model generator configured to
(1) link each code entity with the design entities; and,
(2) generate a relational meta model based on the linkage;
(c) a single entity consistency checking module, the single entity consistency checking module configured to identify consistency gap in a single entity;
(d) a cross entity consistency checking module, the cross entity consistency checking module configured to identify consistency gap between two entities; and,
(e) a runtime consistency checking module, the runtime consistency checking module configured to identify consistency gap in the software system at run-time.

2. A method for checking consistency of a software system during software system development, the software system comprises a source code and a plurality of design diagrams, each design diagram comprising one or more design entities, the method comprising the steps of:
(a) representing the source code of the software system as a source perspective diagram, the source perspective diagram comprising one or more code entities;
(b) linking each code entity with the design entities;
(c) verifying consistency between the one or more design entities based on a first set of consistency rules;
(d) verifying consistency between the one or more code entities based on a second set of consistency rules; and,
(e) verifying consistency between code entities and design entities based on a third set of consistency rules;
wherein consistency gap in the software system is identified based on the verifications.

3. The method of claim 2 wherein the plurality of design diagrams are selected from a group consisting of a deployment perspective diagram; a requirements perspective diagram; and, a development perspective diagram.

4. The method of claim 2 wherein the code entities represent plurality of objects, the objects being developed in an object oriented programming environment.

5. The method of claim 2 wherein the code entities represent plurality of aspects, the aspects being developed in an aspect oriented programming environment.

6. The method of claim 2 wherein the source perspective diagram and the plurality of design diagrams are represented in Extensible Markup Language Metadata Interchange format.

7. The method of claim 2 wherein the step of verifying consistency between the one or more design entities comprises the steps of:
(a) verifying consistency of a single design entity;
(b) verifying consistency between two or more design entities; and,
(c) verifying runtime consistency of each design entity.

8. The method of claim 2 wherein the step of verifying consistency between the one or more code entities comprises the steps of:
(a) verifying consistency of each code entity;
(b) verifying consistency between two or more code entities; and,
(c) verifying runtime consistency of each code entity.

9. The method of claim 2 further comprises prompting a programmer of the software system regarding the consistency gap.

10. A computer-readable storage medium encoded with program instructions for checking consistency of a software system during software system development, the software system comprises a source code and a plurality of design diagrams, each design diagram comprising one or more design entities, the program instructions when executed by one or more processors causes the one or more processors to perform the steps of:
(a) representing the source code of the software system as a source perspective diagram, the source perspective diagram comprising one or more code entity;
(b) linking each code entity with the design entities;
(c) verifying consistency between the one or more design entities based on a first set of consistency rules;
(d) verifying consistency between the one or more code entities based on a second set of consistency rules; and,
(e) verifying consistency between the code entities and the design entities based on a third set of consistency rules;
wherein consistency gap in the software system is identified based on the verifications.

11. The computer readable-storage medium of claim 10, wherein the plurality of design diagrams are at least one of:
(a) a deployment perspective diagram;
(b) a requirements perspective diagram; and,
(c) a development perspective diagram.

12. The computer readable storage medium of claim 10, wherein the code entities represent plurality of objects, the objects being developed in an object oriented programming environment.

13. The computer readable storage medium of claim 10, wherein the code entities represent plurality of aspects, the aspects being developed in an aspect oriented programming environment.

14. The computer readable storage medium of claim 10, wherein the source perspective diagram and the plurality of design diagrams are represented in Extensible Markup Language Metadata Interchange format.

15. The computer program product of claim 10 wherein the step of verifying consistency between design entities comprises the steps of:
(a) verifying consistency of a single design entity;
(b) verifying consistency between two or more design entities; and,
(c) verifying runtime consistency of each design entity.

16. The computer program product of claim 10, wherein the step of verifying consistency between the one or more code entities comprises:
(a) verifying consistency of each code entity;
(b) verifying consistency between two or more code entities; and,
(c) verifying runtime consistency of each code entity.

17. The computer program product of claim 10 further comprises prompting a programmer of the software system regarding the consistency gap.
